(19) United States
(12) Patent Application Publication
(10) Pub. No.: US 2004/0217568 A1
(43) Pub. Date: Nov. 4, 2004

(54) Stabilizer bar with variable torsional stiffness

(76) Inventor: Mircea Gradu, Wooster, OH (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/646,077

(22) Filed: Aug. 22, 2003

Related U.S. Application Data
(60) Provisional application No. 60/467,093, filed on May 1, 2003.

(51) Int. Cl. B60G 21/055

(52) U.S. Cl. 280/124.107

(57) ABSTRACT

A stabilizer bar for controlling the roll of an automotive vehicle has left and right sections, each provided with a torsion rod and a torque arm. The torsion rods are aligned along a transverse axis and attach to a structural component of the vehicle, while the torque arms are connected to the left and right control arms of the vehicle's suspension system. In addition, the bar has a coupling between the torsion rods of the two sections for controlling the torsional stiffness of the bar. The coupling includes a rotor fitted to one of the torsion rods and a housing fitted to the other torsion rod, with the housing receiving the rotor, such that a cavity exists between the rotor and housing. Both the rotor and housing carry vanes, that alternate so that the vanes of the rotor are located between the vanes of the housing. The cavity enclosed by the housing contains a magneto-rheological fluid. The coupling also includes an electrical coil which surrounds the housing and produces a magnetic field in which the rheological fluid lies. Changes in the magnetic fluid vary the viscosity of the fluid and the torsional stiffness of the stabilizer bar.

### CROSS REFERENCE TO RELATED APPLICATIONS

This application derives priority for U.S. provisional application 60/467,093, filed May 1, 2003, for the invention of Mircea Gradu entitled “Active Roll Control System with Electronically Controlled Torsional Stiffness of the Stabilizer Bar”

### STATEMENT REGARDING FEDERALLY SPONSORED RESEARCH OR DEVELOPMENT

Not Applicable

### BACKGROUND OF THE INVENTION

This invention relates to suspension systems for automotive vehicles and more particularly to a stabilizer bar for a suspension system.

The typical passenger automobile has independently suspended front wheels, as do similar vehicles, such as sports utility vehicles, vans, and light trucks. In order to prevent excessive body roll in such a vehicle when it negotiates turns, particularly at higher speeds, the vehicle is equipped with a stabilizer bar that connects the two sides of its front suspension. The stabilizer bar constitutes nothing more than a torsion bar which extends transversely across the front of the vehicle where it is attached to the frame of the vehicle on each side of the frame, yet is free to rotate relative to the frame. At its ends, the stabilizer bar has torque arms which are attached to the control arms which carry the steering knuckles. As a consequence, the control arms tend to move in unison in the same direction and transfer forces to the frame—forces which modulate and retard roll.

While a stabilizer bar will improve the control and orientation of a vehicle when the vehicle negotiates a turn, particularly at high speeds and on a paved surfaces, it detracts from the ride when the vehicle travels along straight road surfaces. Moreover, it makes travel at low speeds, either straight or through turns, more uncomfortable than it could otherwise be. After all, when one wheel is deflected upwardly, such as by encountering a bump, the other wheel will attempt to lift as well, since the stabilizer bar connects the control arms for both wheels, and oppositely directed forces are applied to the vehicle frame. This can produce a rocking motion when the vehicle travels off road or over uneven road surfaces—a phenomenon sometimes referred to as “antiroll bar waddle”. Hence, different driving conditions call for stabilizer bars with different torsional stiffness. At one extreme are the conditions encountered off road and on secondary roads traveled at relatively low speeds and also those encountered on paved roads in the absence of turns. These conditions require low torsional stiffness. At the other extreme are the conditions encountered when negotiating turns on paved surfaces at high speeds. These conditions require high stiffness. Most stabilizer bars have high stiffness to resist roll and maintain control in turns.

### BRIEF SUMMARY OF THE INVENTION

The present invention resides in a stabilizer bar having a coupling that contains a rheological fluid and means for controlling the viscosity of the fluid. The coupling is configured such that the viscosity of the fluid in it controls the torsional stiffness of the stabilizer bar. The invention also resides in a vehicular suspension system that includes the stabilizer bar.

### BRIEF DESCRIPTION OF THE SEVERAL VIEWS OF THE DRAWINGS

FIG. 1 is a perspective view of a suspension system provided with the stabilizer bar of the present invention;

FIG. 2 is a longitudinal elevational view, partially broken away and in section, of the stabilizer bar;

FIG. 3 is a sectional view taken along line 3-3 of FIG. 2;

FIG. 4 is an exploded perspective view of the stabilizer bar, and

FIG. 5 is a longitudinal sectional view of a modified stabilizer bar.

Corresponding reference characters indicate corresponding parts throughout the several views of the drawings.

### DETAILED DESCRIPTION OF INVENTION

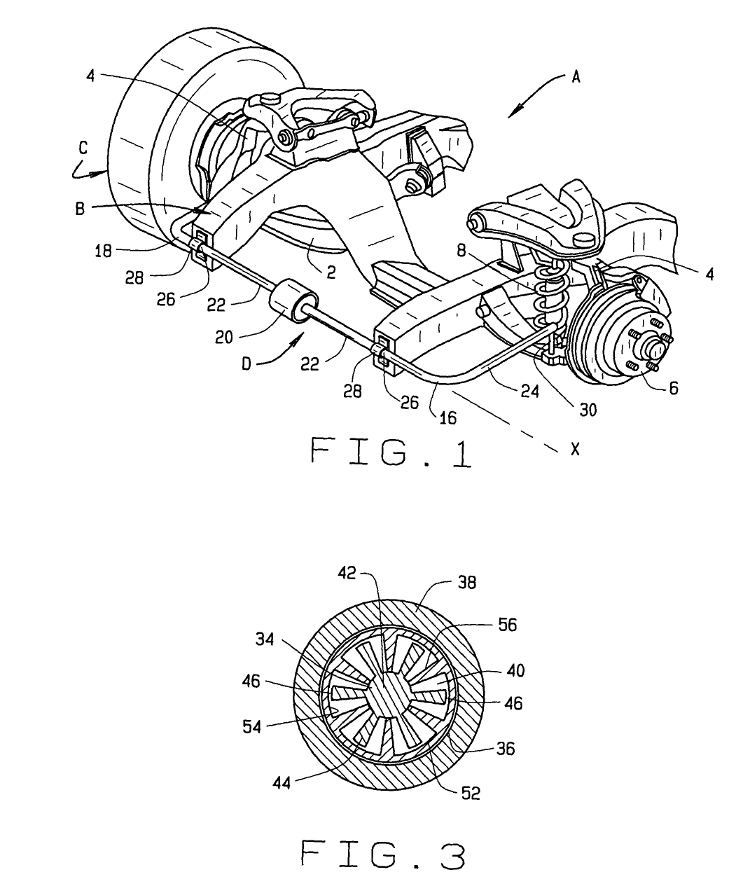

Referring now to the drawings, an automotive vehicle has a suspension system A (FIG. 1) that is attached to a rigid structural component B, such as a frame or a unified body, of the vehicle. The suspension system A couples left and right road wheels C to the structural component B such that the road wheels can displace vertically with respect to the structural component B. The suspension system A includes a stabilizer bar D which is attached to both sides of the structural component B and, in effect connects the left and right wheels C. The arrangement is such that when the body of the vehicle rolls—and with it the structural member B—the stabilizer bar D, being extended between the two wheels C, resists the tendency to roll. But when one of the wheels C is displaced vertically, the bar D may transmit a force to the opposite wheel C and that force urges the opposite wheel C in the same direction as the displacement—at least when bar C possesses a measure of torsional stiffness. Actually, the torsional stiffness of the bar C can be varied to accommodate differing road and driving conditions.

Considering the suspension system A in more detail, it may be a double wishbone or McPherson strut suspension. Either one, on each side of the vehicle, includes (FIG. 1) control arm 2 that is attached to the structural component B such that it can pivot about an axis that extends generally longitudinally with respect to the vehicle. The control arm 2 extends laterally from that pivot axis, and at its outboard is fitted with suspension upright 4, the two being coupled together such that they too can pivot relative to each other. When the suspension upright 4 steers the vehicle, it takes the form of a steering knuckle that is coupled to the control arm 2 through a universal pivot, such as a ball-and-socket joint. In any event, the suspension upright 4 supports a wheel end 6 to which the road wheel C is attached. The typical wheel end 6 has a housing that is attached to the upright 4, a hub to which the road wheel C is secured, and a bearing between the hub and housing to enable the hub and wheel C to rotate on the suspension upright 4 with minimal friction. Finally the suspension system A at each side of the vehicle, has a spring 8 or torsion bar which is extended between the control arm 2 and the structural component B to support the vehicle on the Wheel C toward which the control arm 2 extends is transferred to the control arm 2 and suspension upright 4 though the spring 8.

The stabilizer bar D includes left and right sections 16 and 18 and a coupling 20 located between the sections 16 and 18. Each section 16 and 18, in turn, includes a torsional rod 22 and a torque arm 24. The torsion rods 22 extend transversely on the vehicle and lie along a common transverse axis X. Each is encircled by a guide bushing 26 over which a clamping bracket 28 fits. The brackets 28 are, in turn, attached firmly to the structural component B to thus secure the stabilizer bar D to the component B. Even so, the torsion rods 22 can rotate within their respective guide bushings 26. The torque arms 24 extend from the outboard ends of the torsion rods 22 at a substantial angle with respect to the axis X and lie generally longitudinally in the vehicle. At their ends remote from the torsional rods 22 they are connected to the control arms 2 through vertical links 30—the torque arm 24 of the left section 16 being connected to the left control arm 2 through one link 30 and the torque arm 24 of the right section 16 being connected to the right control arm 2 through another link 30.

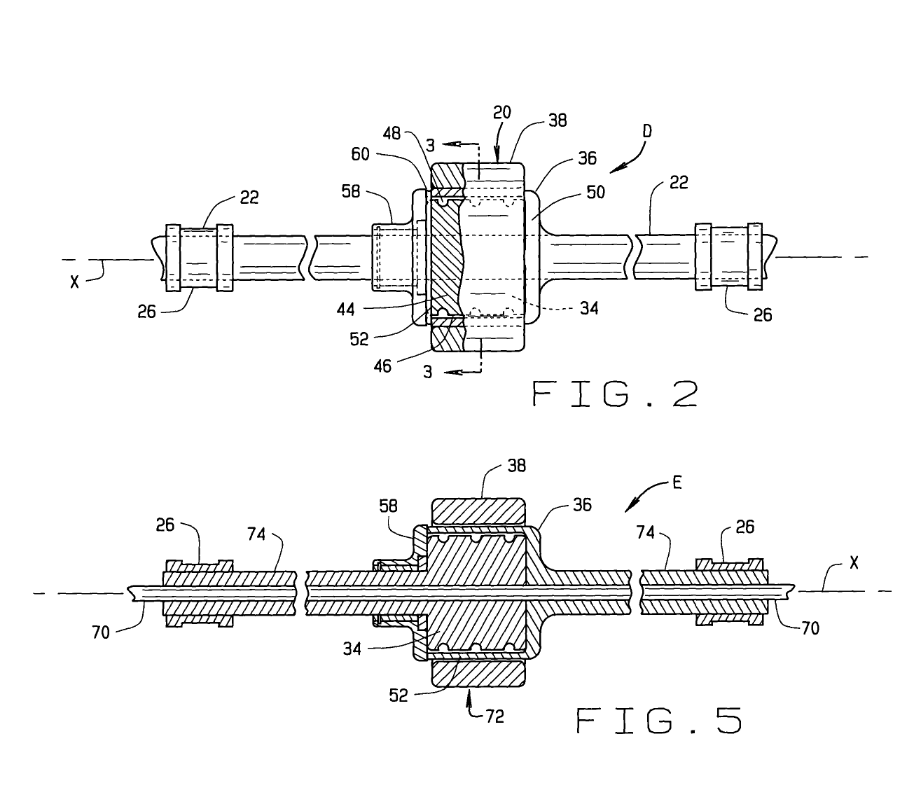

The coupling 20 controls the torsional stiffness of the stabilizer bar C. It basically includes (FIGS. 2-4) a rotor 34 which is carried by the left section 16, a housing 36 which is carried by the right section 18 and receives the rotor 34, and an electrical coil 38 which surrounds the housing 36. In addition, the coupling 20 includes a magneto-rheological fluid 40 which is contained within the housing 36 and surrounds the rotor 34.

The rotor 34 is attached firmly to the inboard end of the torsion rod 22 for the left section 16. It has a hub 42 and formations in the form of blades or vanes 44 (FIG. 3) which project radially from the hub 42 so that the vanes 44 are oriented radially with respect to the axis X. The vanes 44 have outer edges 46 out of which slots 48 open (FIGS. 2 & 4). The edges 46 form a cylindrical envelope having its center along the axis X.

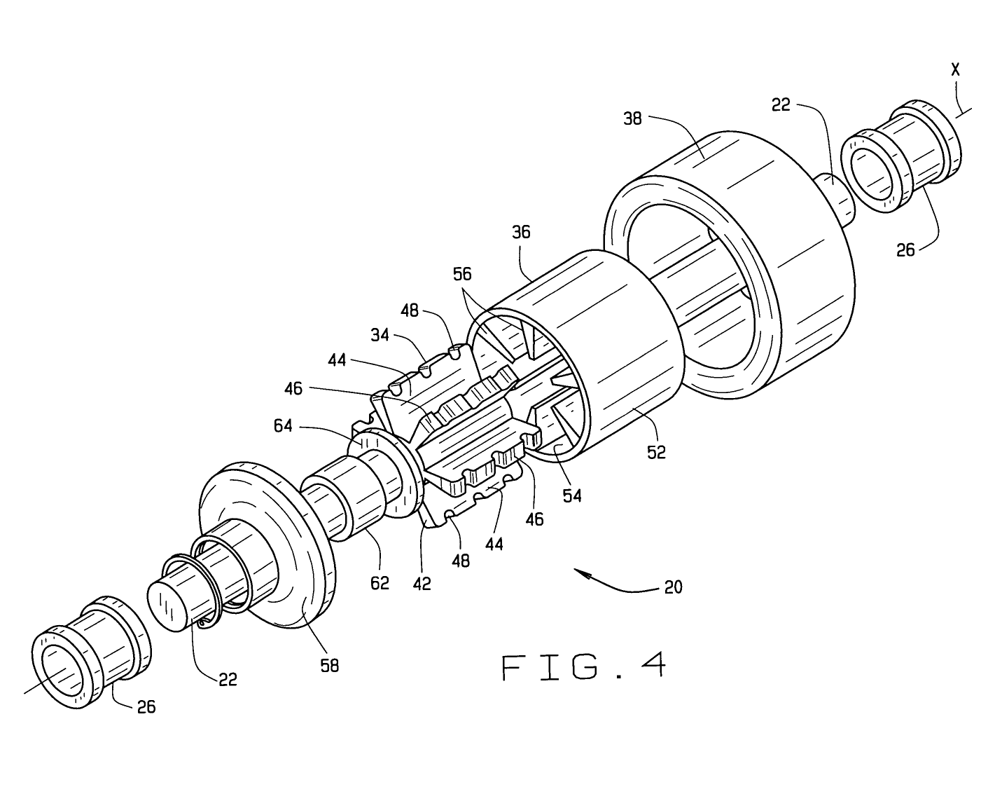

The housing 36 encloses the rotor 34. To this end, it has an end wall 50 (FIG. 2) that is attached firmly to the inboard end of the torsion rod 22 for the right section 18 and a cylindrical wall 52 (FIG. 4) which extends axially from the end wall 50. The cylindrical wall 52 possesses an interior surface 54 which is cylindrical and has its center at the axis X. Its diameter slightly exceeds the diameter of the cylindrical enveloped formed by the outer edges 46 of the rotor 34. Like the rotor 34, the housing 36 has formations in the form of blades or vanes 56 (FIG. 3), and they project inwardly from the cylindrical wall 52 and at their inner ends contact or lie in close proximity to the surface of the hub 42 on the rotor 34. While the housing vanes 56 occupy the spaces between vanes 44 of the rotor 34, they do not occupy the entirety of those spaces. Thus, a cavity exists within the housing 36 and around the hub 42 of the rotor 34. The number and thickness of the vanes 44 and 56 is such that the coupling 20 can accommodate relative rotation between the left and right sections 16 and 18 of the stabilizer bar C. Normally, the housing vanes 56 are centered between the rotor vanes 44.

In addition, the housing 36 includes an end cap 58 (FIGS. 2 & 4) which fits around the torsion rod 22 of the left section 16 and is secured to the end of the cylindrical wall 54 at a fluid-light joint 60. The end cap 58 contains a sleeve bearing 62 which enables the rotor 34 to rotate relative to the housing 36 while keeping their respective axes aligned along the transverse axis X. The end cap 58 also contains a seal 64 which establishes a dynamic fluid barrier between the rotor 34 and the torsion rod 22 to which it is connected, on the one hand, and the housing 36, on the other. This prevents the Theological fluid 40 from migrating along the torsion rod 22 of the left section 16, so that it remains in the cavity enclosed by the housing 36.

The coil 38 is attached to the housing 36 and encircles the cylindrical wall 54 of the housing 36. When energized, it produces a magnetic field within the interior of the housing 36. The magneto-rheological fluid 40, being within the cavity enclosed by the housing 36, also lies within the magnetic field produced by the coil 38.

The fluid 40 occupies the entirety of the cavity. No air or gas pockets to speak of exist within the cavity or the fluid 40 in it. The viscosity of the fluid 40 depends on the strength of the magnetic field in which the fluid 40 lies, and that strength depends of the magnitude of the current passing through the coil 38. By varying the magnetic field produced by the coil 38, one can vary the viscosity of the fluid 40 from roughly equivalent to that of water to almost a solid—the stronger the field, the greater the viscosity.

When the field is weak or nonexistent, the fluid flows freely and will pass easily between the edges 44 of the rotor vanes 42 and the cylindrical interior surface 54 of the cylindrical wall 52 for the housing 36. It also flows freely through the slots 48. As a consequence, the rotor 34 will rotate in the housing 36 with little impedance from the fluid 40. This condition is ideal for driving straight at any speed over paved roads or for driving at slow speeds over unpaved secondary roads and rough terrain.

However, when the coil 38 conducts current, the fluid becomes more viscous and flows less freely over the edges 44 of the vanes 42 and through the slots 46. As a consequence, the fluid 40 offers resistance to rotation of the rotor 34 within the housing 36—and the amount of resistance depends on the magnitude of the current in the coil 38 and the strength of the field that it produces. The resistance to rotation stiffens the stabilizer bar D. Some resistance is desired when the vehicle negotiates turns on paved road surfaces, with more resistance being desired when negotiating turns at high vehicle speeds, this to exert forces on the structural member B that prevent excessive roll of the vehicle body.

The amount of current supplied to the coil 38 may be controlled manually such as by a rheostat. Preferably, it is controlled by an automatic system which includes sensors that detect the speed of the vehicle, vertical acceleration to detect the condition of the surface over which the vehicle travels, and lateral acceleration to determine the intensity of turns negotiated.

A modified stabilizer bar E (FIG. 5) has a torsion rod 70 which extends uninterrupted between the two torque arms 24 just as in a conventional torsion rod. And while it may be perceived as two torsion rods 22 joined together, it passes through a torque coupling 72 which is very similar to the coupling 20, except that the hub 42 of the rotor 34 is hollow, and both the rotor 34 and housing 36 have tubular extensions 74 extended away from cavity containing the rheological fluid 40. The extensions 74 are clamped or otherwise attached securely to the torsion rod 70 remote from the rotor 34 and housing 36. Thus, the torsion rod 70 extends through both the rotor 34 and the housing 36 of the coupling 72 and between the remote ends of the two tubular extensions 74 so the torsion rod 70 may twist in the coupling 72 and extensions 74.

When it does, relative rotation occurs between the rotor 34 and the housing 36. If the coil 38 is energized, it will increase the viscosity of the fluid 40 in the coupling 72 and the fluid 40 will resist or impede that relative rotation, thereby stiffening the torsion rod 70. Thus, the coupling 72 controls the torsional stiffness of the rod 72 and the stabilizer bar E of which it is a part.

Either stabilizer bar D or E may be extended between the control arms of the rear suspension of an automotive vehicle on even connected to the left and right components of a rear suspension that does not have control arms. Also, the vanes 56 of the housing 36 may be provided with slots 48 in lieu of the vanes 44 of the rotor 34 or both may have slots 48. Different configurations, such as apertures, may be used in lieu of the slots 48. Other rheological fluids, such as those which respond to electrical currents passing through them, may be used in the cavity enclosed by the housing 36 in lieu of the magneto-rheological fluid 40, in which event the coil 38 may not be necessary.

What is claimed is:

1. A stabilizer bar for an automotive vehicle, said bar comprising:
first and second torsion rods which are aligned;
a coupling including first and second coupling members attached to the first and second torsion rods, respectively, such that the rods can rotate relative to each other about the axis, the members defining a cavity and having formations which are exposed to the cavity;
a rheological fluid in the cavity defined by the first and second coupling members, whereby the fluid will resist rotation of the members relative to each, with the magnitude of the resistance depending of the viscosity of the fluid; and
means for varying the viscosity of the Theological fluid in the cavity.

2. A stabilizer bar according to claim 1 wherein the first coupling member is rotor and the second coupling member is a housing which surrounds the rotor; and wherein the rotor and housing have a common axis.

3. A stabilizer bar according to claim 2 wherein the formations on the rotor are vanes which project outwardly away from the axis and the formations on the housing are vanes which project inwardly toward the axis and into spaces between the vanes on the rotor.

4. A stabilizer according to claim 3 wherein the housing has a cylindrical wall from which the vanes of the housing project.

5. A stabilizer bar according to claim 1 wherein the Theological fluid is responsive to magnetic fields, and wherein the means for varying the viscosity of the Theological fluid is an electric coil.

6. A stabilizer bar according to claim 5 wherein the housing includes a wall that surrounds the rotor; and wherein the coil surrounds the wall.

7. A stabilizer bar according to claim 1 wherein the first and second torsion rods are separate and rotate relative to each other.

8. A stabilizer bar according to claim 1 wherein the first and second torsion rods are unified; wherein the unified rods extend through the coupling; and wherein the first and second coupling members are attached to the unified torsion rod remote from the cavity containing the rheological fluid so that the unified rod can twist in the region between which it is attached to the coupling members.

9. In combination with a structural component of an automotive vehicle, which further includes left and right control arms pivoted on the vehicle about axes that extend generally longitudinally of the vehicle, wheel ends that are connected to the control arms remote from the axes about which the control arms pivot, a stabilizer bar for reducing roll of the structural component in turns, said bar comprising:
left and right sections, each having a torsion rod and a torque arm, the torsion rods of the two sections being aligned along an axis that extends transversely of the vehicle and being attached to the structural component such that the sections can rotate relative to the structural component about the axis, the torque arm of the left section extending from the torsion rod of the left section and remote from that torsion rod being attached to the left control arm, the torque arm of the right section extending from the torsion rod of the right section and remote from that torsion rod being attached to the right control arm;
a coupling located between the left and right sections and including a left coupling member attached to the torsion rod of the left section and a right coupling member attached to the torsion rod of the right section, the left and right coupling members forming a cavity and having formations which are exposed to the cavity;
a magneto-rheological fluid in the cavity; and
an electrical coil that produces a magnetic field that passes through the cavity and controls the viscosity of the rheological fluid.

10. The combination according to claim 9 wherein one of the coupling members is a rotor and the other coupling member is a housing that surrounds the rotor.

11. The combination according to claim 10 wherein the formations on the rotor are vanes which project outwardly away from the transverse axis.

12. The combination according to claim 11 wherein the formations on the housing are vanes which project inwardly toward the axis and into spaces between the vanes and the rotor.

13. The combination according to claim 10 wherein the formations on the housing are vanes which project inwardly toward the axis.

14. The combination according to claim 10 wherein the coil surrounds the housing.

15. The combination according to claim 14 wherein the housing has a generally cylindrical wall and the coil surrounds the cylindrical wall.

16. The combination according to claim 9 wherein the torsion rods of the left and right sections are detached.

17. The combination according to claim 9 wherein the torsion rods of the left and right sections are unified and pass through the coupling; wherein the left coupling member includes a tubular extension which extends away from the cavity and receives the torsion rod of the left section; wherein the right coupling member includes a tubular extension which extends away from the cavity and receives the torsion rod of the right section; wherein the tubular extensions of the left and right members are secured to the torsion rods of the left and right sections, respectively, remote from the cavity.
